(19) United States
(12) Patent Application Publication
(10) Pub. No.: US 2003/0091064 A1
(43) Pub. Date: May 15, 2003

(54) Systems and methods for creating covert channels using packet frequencies

(76) Inventors: Craig Partridge, East Lansing, MI (US); David B. Cousins, Barrington, RI (US)

Correspondence Address: Leonard C. Suchyta, c/o Christian Andersen, Verizon Corporate Services Group Inc., 600 Hidden Ridge, HQE03H01, Irving, TX, 75038, US

(21) Appl. No.: 10/265,961

(22) Filed: Oct. 7, 2002

Related U.S. Application Data
(60) Provisional application No. 60/334,890, filed on Nov. 15, 2001.
(60) Provisional application No. 60/355,573, filed on Feb. 5, 2002.

(51) Int. Cl. H04J 3/16; H04J 3/22

(52) U.S. Cl. 370/465

(57) ABSTRACT

A system (130) receives a covert message from a transmit device (110). The system (130) monitors the transmission of packets from the transmit device (110) to a receive device (120). The transmit device (110) transmits the packets using a transmission pattern that is unknown to the receive device (120). The system (130) receives a covert message from the monitored transmission using the transmission pattern.

### RELATED APPLICATION

This application claims priority under 35 U.S.C. §119 based on U.S. Provisional Application No. 60/334,890, filed Nov. 15, 2001, and U.S. Provisional Application No. 60/355,573, filed Feb. 5, 2002, the disclosures of which are incorporated herein by reference.

This application is related to commonly assigned U.S. patent application Ser. No. 10/112,001, filed Oct. 19, 2001, the entire contents of which are incorporated herein by reference.

### FIELD OF THE INVENTION

The present invention relates generally to communication systems and, more particularly, to systems and methods for communicating messages over encrypted data streams.

### BACKGROUND OF THE INVENTION

Many techniques exist for transmitting messages over a network in a secure manner. For example, a transmit device may encrypt a message using an encryption key prior to sending it to the destination device. If the destination device has the encryption key, it may decrypt and view the message.

In some instances, it is desirable to be able to transmit a covert message to a destination device while at the same time appearing to transmit legitimate traffic to some other device. For example, in the classic “spy” scenario, a spy may wish to communicate a covert message to his colleagues. If the spy is in the enemy's territory, it may be impossible for the spy to use a communication device, such as a computer, to transmit a message directly to his colleagues without being detected.

Accordingly, there is a need in the art for systems and methods for creating covert transmission channels through which messages may be transmitted. An example of a way to create such a covert channel is steganography, where a digital message is encoded in certain (low importance) bits in digital photographs or music. The fundamental idea of a covert channel is to transmit data via a channel that was not designed or expected to pass messages. Another useful feature of a covert channel is that the typical observer has great difficulty perceiving that communication is taking place.

### SUMMARY OF THE INVENTION

Systems and methods consistent with the present invention address this and other needs by providing a mechanism for communicating covert messages in data streams.

In accordance with the purpose of this invention as embodied and broadly described herein, a method for sending a message between a first device and a third device is provided. The method includes transmitting packets from the first device to a second device at a fixed interval, where the fixed interval is known by the third device. The method further includes monitoring, via the third device, the transmitting of packets from the first device to the second device, and detecting, via the third device, a message from the first device when packets are detected at the fixed interval.

In another implementation consistent with the present invention, a system for transmitting a covert message is provided. The system includes a memory storing a value set to a fixed interval and a transmitter. The transmitter receives the value and transmits a series of two or more packets, each transmission separated in time by the fixed interval. A different device is capable of detecting a covert message firm the system when the packets are transmitted at the fixed interval.

In yet another implementation consistent with the present invention, a method for sending a message between a first device and a third device is provided. The method includes transmitting a group of packet streams from the first device to a second device at a group of corresponding intervals, monitoring, via the third device, the transmitting of packets from the first device to the second device, and receiving, via the third device, a message from the first device when packets are detected at the group of corresponding intervals during a time period.

In still another implementation consistent with the present invention, a computer-readable medium containing instructions for controlling one or more processors to perform a method for receiving a covert message from a transmit device is provided. The method includes monitoring a transmission of packets from the transmit device to a receive device, where the transmit device varies the transmission of packets from a first transmission interval to a second transmission interval over a predetermined time period, and receiving a covert message from the transmit device when packets are detected at an interval that varies from the first transmission interval to the second transmission interval over the predetermined time period.

In a further implementation consistent with the present invention, a system for receiving a covert message is provided. The system includes first logic configured to monitor a transmission of packets from a first device to a second device, where the first device transmits the packets such that the interval between packet transmissions creates a set of frequencies and the set of frequencies are managed to achieve a spread spectrum transmission pattern. The system further includes second logic configured to receive a covert message from the monitored transmission using the spread spectrum transmission pattern.

In still a further implementation consistent with the present invention, a method for sending a message between a first device and a third device is provided. The method includes transmitting packets from the first device to a second device using a transmission pattern that is unknown to the second device, monitoring, via the third device, the transmitting of packets from the first device to the second device, and receiving, via the third device, a message from the monitored transmission using the transmission pattern.

In still a further implementation consistent with the present invention, a method for sending a message between a first device and a third device is provided. The method includes transmitting packets from the first device to a second device using a transmission patterns that represents, based on the timing of individual packet transmissions, a portion of a frequency spectrum. The first device uses a spectrum-based transmission technique to covertly transmit the message to the third device in the transmission of packets to the second device. The method further includes monitoring, via the third device, the transmission of packets from the first device to the second device and receiving, based on the monitoring, the covert message from the first device when the first device transmits packets using the transmission pattern.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 illustrates an exemplary system in which systems and methods, consistent with the present invention, may be implemented;

FIG. 2 illustrates an exemplary configuration of the transmitting device of FIG. 1;

FIG. 3 illustrates an exemplary configuration of the eavesdropping device of FIG. 1; and

FIGS. 4-8 illustrate exemplary processes for creating a covert channel between a transmit device and an eavesdropping device in an implementation consistent with the present invention.

### DETAILED DESCRIPTION

The following detailed description of implementations consistent with the present invention refers to the accompanying drawings. The same reference numbers in different drawings may identify the same or similar elements. Also, the following detailed description does not limit the invention. Instead, the scope of the invention is defined by the appended claims and equivalents.

Implementations consistent with the present invention create channels through which covert messages may be transmitted. A transmit device transmits packets to a receive device based on a transmission pattern known only to the transmit device and an eavesdropping device. By knowing this transmission pattern, the eavesdropping device can detect messages in the transmission times of packets from the transmit device to the receive device that are invisible to the receive device.

### Exemplary System

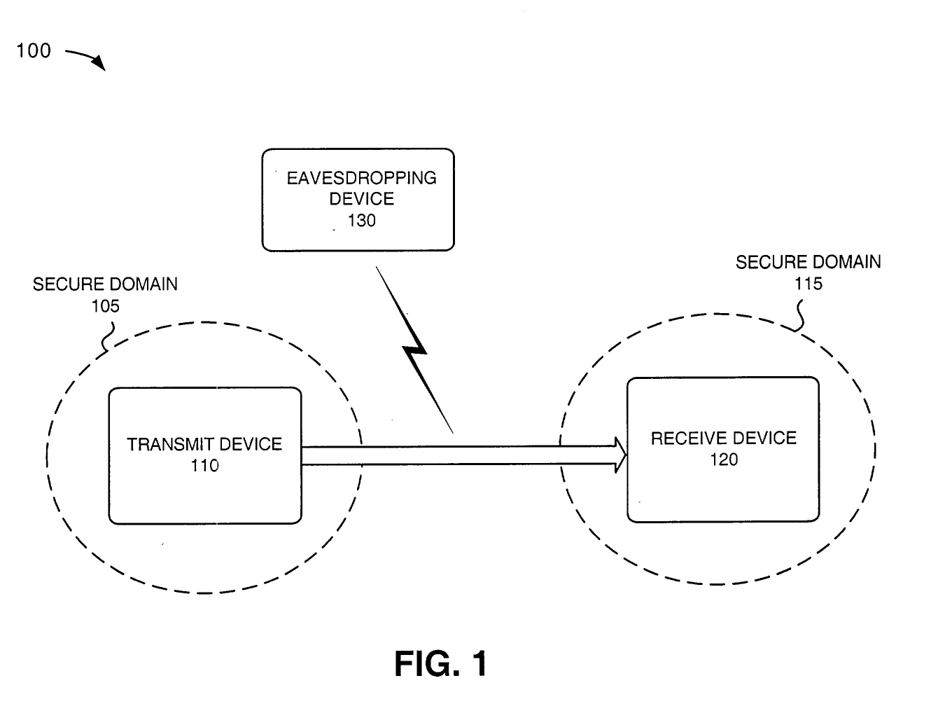

FIG. 1 illustrates an exemplary system 100 in which systems and methods, consistent with the present invention, may be implemented. System 100 includes two secure domains 105 and 115 that include devices 110 and 120, respectively, and an eavesdropping device 130 located in a-non-secure domain. Only a few components are illustrated in FIG. 1 for simplicity. It will be appreciated that the techniques described herein are equally applicable to systems having more or fewer devices than illustrated in FIG. 1.

The secure domains 105 and 115 include areas in which all traffic either leaving or entering the domain is encrypted in a manner that makes traffic unintelligible to listening parties other than those in the receiving secure domain. In the system illustrated in FIG. 1, for example, traffic transmitted from secure domain 105 to secure domain 115 is unintelligible to any listening party, such as eavesdropping device 130.

Device 110 may include one or more devices capable of transmitting data to device 120 in an encrypted or unencrypted manner. For example, device 110 may include a computer system, such as a mainframe, minicomputer, or personal computer. It will be appreciated that device 110 may include any device capable of sending encrypted or unencrypted data. Device 110 may transmit data to device 120 via a wired, wireless, or optical connection. Device 110 may encrypt data transmitted to device 120 using any well-known encryption technique, such as a key-encryption technique.

Device 120 may include one or more devices capable of receiving encrypted or unencrypted data from device 110 and decrypting the data (when applicable) in a well known manner. Device 120 may receive data from device 110 via a wired, wireless, or optical connection.

Eavesdropping device 130 may include one or more devices capable of monitoring traffic transmitted from transmit device 110. For example, eavesdropping device 130 may include a computer system, such as a mainframe, minicomputer, or personal computer, or any other type of device capable of monitoring traffic transmitted between transmit device 110 and receive device 120. In one implementation, eavesdropping device 130 may include a network sniffer. Other types of eavesdropping devices 130 may be used in other implementations consistent with the present invention.

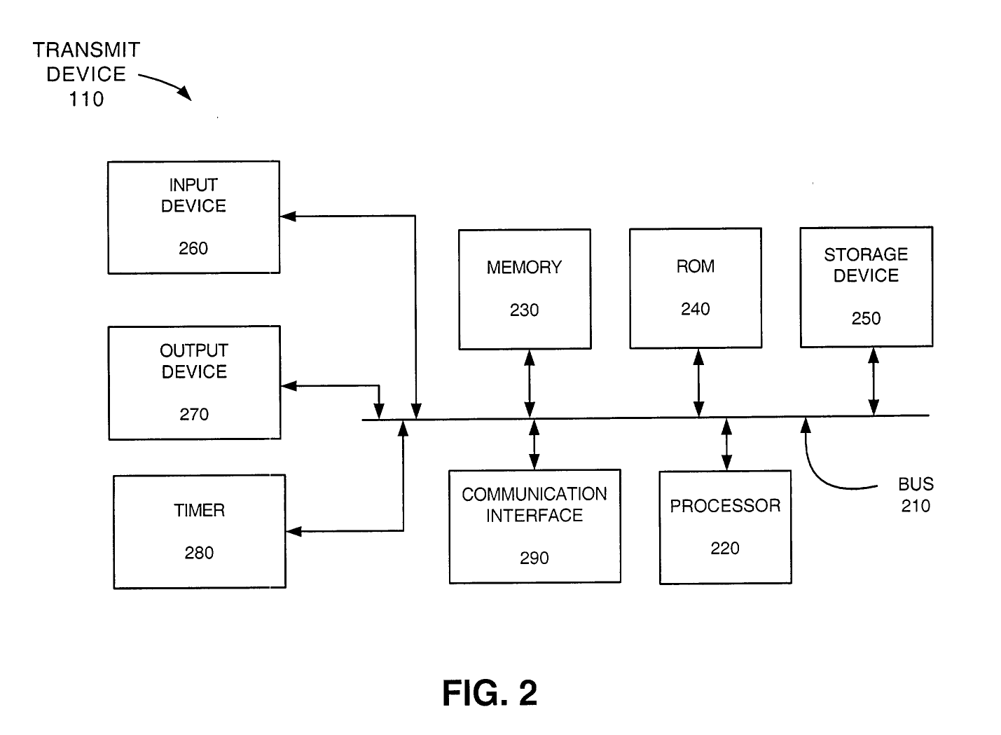

FIG. 2 illustrates an exemplary configuration of transmit device 110 in an implementation consistent with the present invention. In FIG. 2, transmit device 110 includes a bus 210, a processor 220, a memory 230, a read only memory (ROM) 240, a storage device 250, an input device 260, an output device 270, a timer 280, and a communication interface 290. Bus 210 may include one or more conventional buses that permit communication among the components of transmit device 110.

Processor 220 may include any type of conventional processor or microprocessor that interprets and executes instructions. Memory 230 may include a random access memory (RAM) or another type of dynamic storage device that stores information and instructions for execution by processor 220. Memory 230 may also be used to store temporary variables or other intermediate information during execution of instructions by processor 220.

ROM 240 may include a conventional ROM device and/or another type of static storage device that stores static information and instructions for processor 220. Storage device 250 may include a magnetic disk or optical disk and its corresponding drive and/or some other type of magnetic or optical recording medium and its corresponding drive for storing information and/or instructions.

Input device 260 may include any conventional mechanism or combination of mechanisms that permits an operator to input information to transmit device 110, such as a keyboard, a mouse, a microphone, a pen, a biometric input device, such as voice recognition device, etc. Output device 270 may include any conventional mechanism or combination of mechanisms that outputs information to the operator, including a display, a printer, a speaker, etc.

Timer 280 may include a clock or any clock-like device capable of providing a timing signal to communication interface 290. Communication interface 290 may include any transceiver-like mechanism that enables transmit device 110 to communicate with other devices and/or systems, such as receive device 120. For example, communication interface 290 may include a modem or an Ethernet interface to a network. Through the use of a timing signal from timer 280, communication interface 290 can control the intervals at which packets are transmitted from transmit device 10.

Execution of sequences of instructions contained in a computer-readable medium may cause processor 220 to implement functional operations, such as encrypting data and causing the data to be transmitted in predetermined transmission patterns, as described below. A computer-readable medium may include one or more memory devices, such as memory 230, or carrier waves. Such instructions may be read into memory 230 from another computer-readable medium, such as storage device 250, or from another device via communication interface 290. In alternative embodiments, hardwired circuitry may be used in place of or in combination with software instructions to implement the present invention. Thus, the present invention is not limited to any specific combination of hardware circuitry and software.

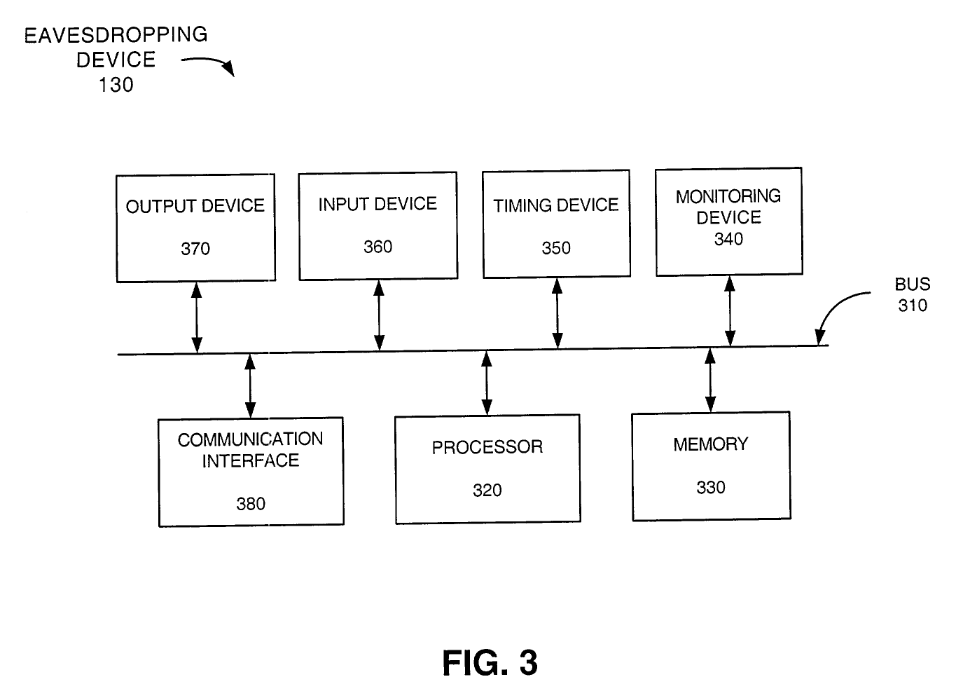

FIG. 3 illustrates an exemplary configuration of eavesdropping device 130 in an implementation consistent with the present invention. As illustrated, eavesdropping device 130 includes a bus 310, a processor 320, a memory 330, a monitoring device 340, a timing device 350, an input device 360, an output device 370, and a communication interface 380. Bus 310 permits communication among the components of eavesdropping device 130.

Processor 320 may include any type of conventional processor or microprocessor that interprets and executes instructions. Memory 330 may include a RAM or another type of dynamic storage device that stores information and instructions for execution by processor 320; a ROM or another type of static storage device that stores static information and instructions for use by processor 320; and/or some type of magnetic or optical recording medium and its corresponding drive.

Monitoring device 340 may include any type of device capable of monitoring and/or tracking when encrypted or unencrypted traffic is transmitted between transmit device 110 and receive device 120. For example, monitoring device 340 may include a network sniffer or some other similar type of mechanism. Timing device 350 may include any type of device capable of timestamping traffic monitored by monitoring device 340.

Input device 360 may include any conventional mechanism or combination of mechanisms that permits an operator to input information to eavesdropping device 130, such as a keyboard, a mouse, a pen, a biometric mechanism, and the like. Output device 370 may include any conventional mechanism or combination of mechanisms that outputs information to the operator, including a display, a printer, a speaker, etc. Communication interface 380 may include any transceiver-like mechanism that enables eavesdropping device 130 to communicate with other devices and/or systems.

Execution of the sequences of instructions contained in a computer-readable medium, such as memory 330, causes processor 320 to implement functional operations, such as the ones described below. Such instructions may be read into memory 330 from another computer-readable medium or from another device via communication interface 380. In alternative embodiments, hardwired circuitry may be used in place of or in combination with software instructions to implement the present invention. Thus, the present invention is not limited to any specific combination of hardware circuitry and software.

### Exemplary Processing

In each of the processes that follow, transmit device 110 sends traffic to receive device 120. It is assumed that the technique by which transmit device 110 transmits the traffic to receive device 120 (e.g., transmitting traffic at specific intervals) is known ahead of time by transmit device 110 and eavesdropping device 130. When the transmission technique by which this traffic is transmitted by transmit device 110 is known by transmit device 110 and eavesdropping device 130, transmit device 110 may create a covert channel by which to transmit messages to eavesdropping device 130.

Typically a conversation between two parties, such as transmit device 110 and receive device 120, has a fundamental frequency based upon the distance between the two communicating ends of the conversation. A conversation may also have a fundamental frequency of transmission (e.g., television which transmits a screen of data roughly every 1/35^{th} of a second). Even if the conversations are encrypted, by tracking when the packets in the conversations are transmitted, these fundamental frequencies can be discovered through certain forms of frequency analysis, such as through the use of Fast Fourier Transform, Cepstrum, or Lomb Periodogram. Frequencies may be observed even if traffic from multiple sources is sent through a single encrypter, router, or other multiplexing device (so that multiple different transmissions and conversations are commingled).

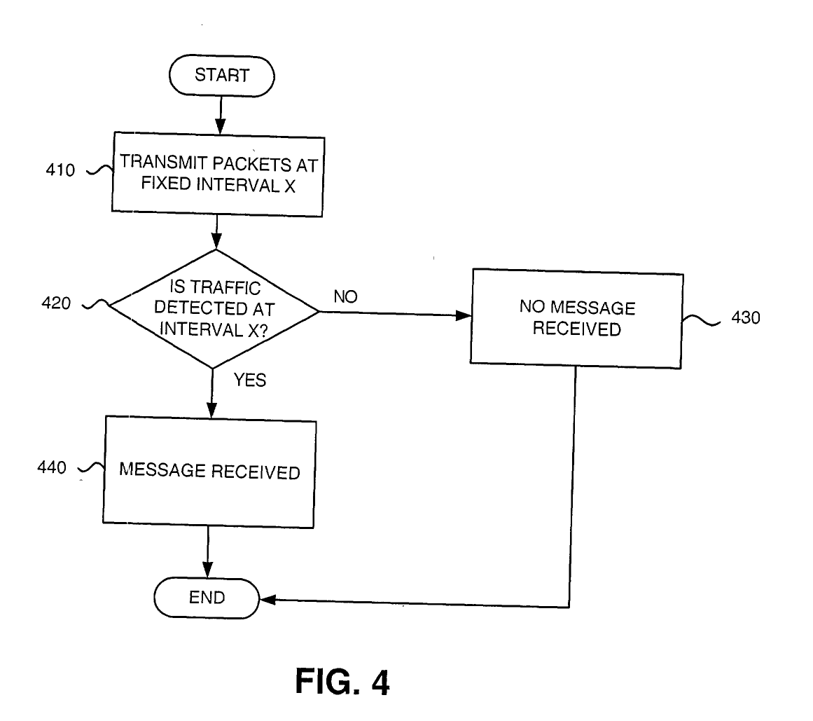

FIG. 4 illustrates a first exemplary process for creating a covert channel between a transmit device 110 and an eavesdropping device 130 in an implementation consistent with the present invention. In this implementation, transmit device 110 transmits packets to receive device 120 at a fixed interval, X (act 410). To properly create the covert channel, the value of X is known by both transmit device 110 and eavesdropping device 130 prior to any attempted communication between transmit device 110 and eavesdropping device 130.

Eavesdropping device 130 may determine whether traffic is detected at the fixed interval X (act 420). To make such a determination, eavesdropping device 130 may, for example, perform frequency analysis on the traffic channel between transmit device 110, and receive device 120 looking for a spike in the frequency graph at time X. If traffic is not detected at the fixed interval X, eavesdropping device 130 may determine that no message has been transmitted by transmit device 110 (act 430). If, on the other hand, eavesdropping device 130 detects traffic at the fixed interval X, eavesdropping device 130 may determine that a message has been sent by transmit device 110 (act 440).

The message transmitted to eavesdropping device 130 via the covert channel may consist of a single bit indicating, for example, “hello,” or it may consist of a series of 1's and 0's. In this latter situation, transmit device 110 may, for example, transmit a “1” by transmitting two or more packets whose transmission times are separated by the predetermined time interval X and may transmit a “0” by not transmitting any packets at the predetermined interval after, for example, some initial transmission indicating that transmission is underway. Other techniques may alternatively be used.

In one implementation, the value of X is chosen so that its occurrence as a frequency in normal traffic is unlikely. This choice reduces the possibility that some other party happens to be transmitting traffic through the network at frequency X. It will be appreciated that this uncommon frequency may vary based on the network by which transmit device 110 communicates with receive device 120. Different networks and different types of traffic may have different characteristic frequency signatures. Therefore, it may be important that transmit device 110 have some sense of the network by which traffic will be transmitted in order to decide what frequency (or frequencies) to use. One exemplary value might be to set X to 3 seconds (i.e., 0.3 Hz) in a network where most communications occur in times on the order of a few hundred milliseconds (and thus where normal traffic patterns will have frequencies of 5 Hz or higher).

In an alternative embodiment, transmit device 110 may use two uncommon frequencies for creating two covert channels. One frequency may always be present to indicate to eavesdropping device 130 that a transmission is underway. The other frequency may be used to send a desired message to eavesdropping device 130. This technique eliminates the need for an initial signal that a transmission is underway. Rather, the eavesdropping device 130 can detect a message is in progress by testing for the presence of the first frequency, and then interpreting the message sent on the second frequency.

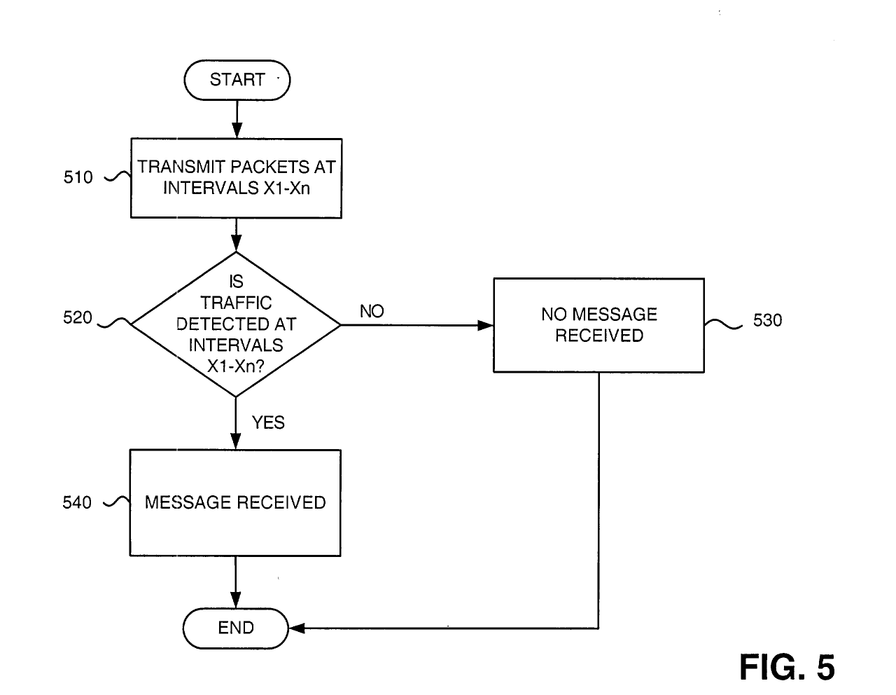

FIG. 5 illustrates a second exemplary process for creating a covert channel between a transmit device 110 and an eavesdropping device 130 in an implementation consistent with the present invention. In this implementation, transmit device 110 transmits packets to receive device 120 at a series of intervals, X1, X2, . . . , Xn (act 510). In this process, transmit device 110 begins by transmitting packets at interval X1. After a predetermined time T, transmit device 110 begins transmitting packets at interval X2. Then, after time T, transmit device 110 begins transmitting packets at interval X3, and so on through interval Xn. Similar to the process described above, the values of X1-Xn are known by both transmit device 110 and eavesdropping device 130 prior to any attempted communication between transmit device 110 and eavesdropping device 130.

Eavesdropping device 130 may determine whether traffic is detected at the predetermined intervals X1-Xn (act 520). To make such a determination, eavesdropping device 130 may, for example, perform frequency analysis on the traffic channel from transmit device 110 to receive device 120 looking for spikes in the frequency graph at times X1-Xn in the prescribed sequence (i.e., X1, X2, X3, . . . , Xn). If traffic is not detected at the predetermined intervals X1-Xn and in the prescribed order, eavesdropping device 130 may determine that no message has been transmitted by transmit device 110 (act 530). If, on the other hand, eavesdropping device 130 detects traffic at the predetermined intervals X1-Xn and in the prescribed order, eavesdropping device 130 may determine that a message has been sent by transmit device 110 (act 540). At least some of the values of X1-Xn may be chosen such that their occurrence in normal traffic would be unlikely. This increases the probability that when eavesdropping device 130 detects traffic at the predetermined intervals X1-Xn and in the prescribed order that it is in fact a message from transmit device 110.

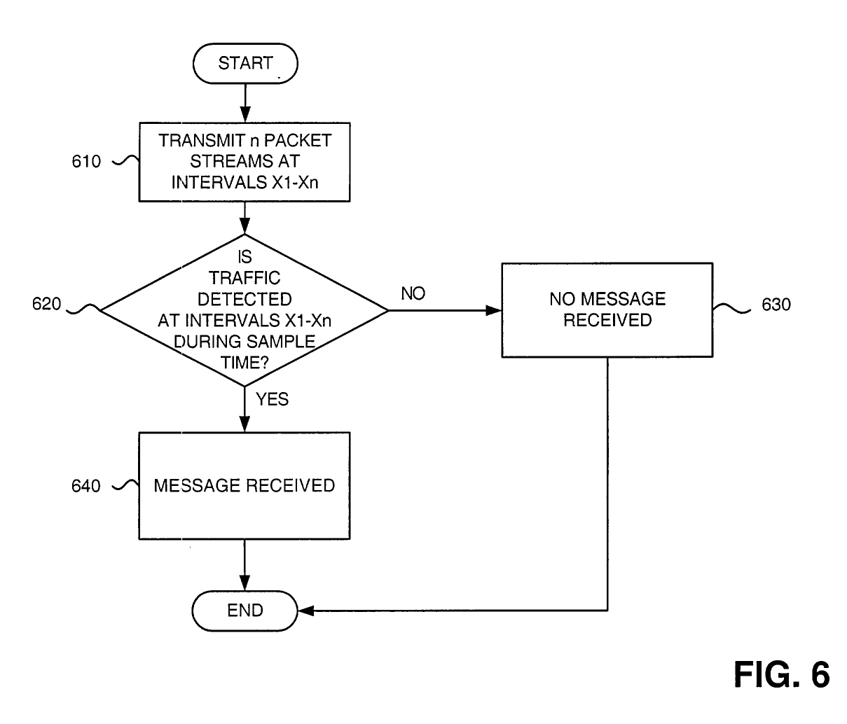

FIG. 6 illustrates a third exemplary process for creating a covert channel between a transmit device 110 and an eavesdropping device 130 in an implementation consistent with the present invention. In this implementation, transmit device 110 transmits n packet streams to receive device 120 at the same time, where each packet stream Pi is transmitted at interval Xi (act 610). Similar to the processes described above, the values of n and X1-Xn are known by both transmit device 110 and eavesdropping device 130 prior to any attempted communication between transmit device 110 and eavesdropping device 130.

Eavesdropping device 130 may determine whether traffic is detected at the predetermined intervals X1-Xn during a given timeframe (act 620). To make such a determination, eavesdropping device 130 may, for example, perform frequency analysis on the channel looking for spikes in the frequency graph at times X1-Xn within the given timeframe. If traffic is not detected at the predetermined intervals X1-Xn during the given timeframe, eavesdropping device 130 may determine that no message has been transmitted by transmit device 110 (act 630). If, on the other hand, eavesdropping device 130 detects traffic at the predetermined intervals X1-Xn during the given timeframe, eavesdropping device 130 may determine that a message has been sent by transmit device 110 (act 640).

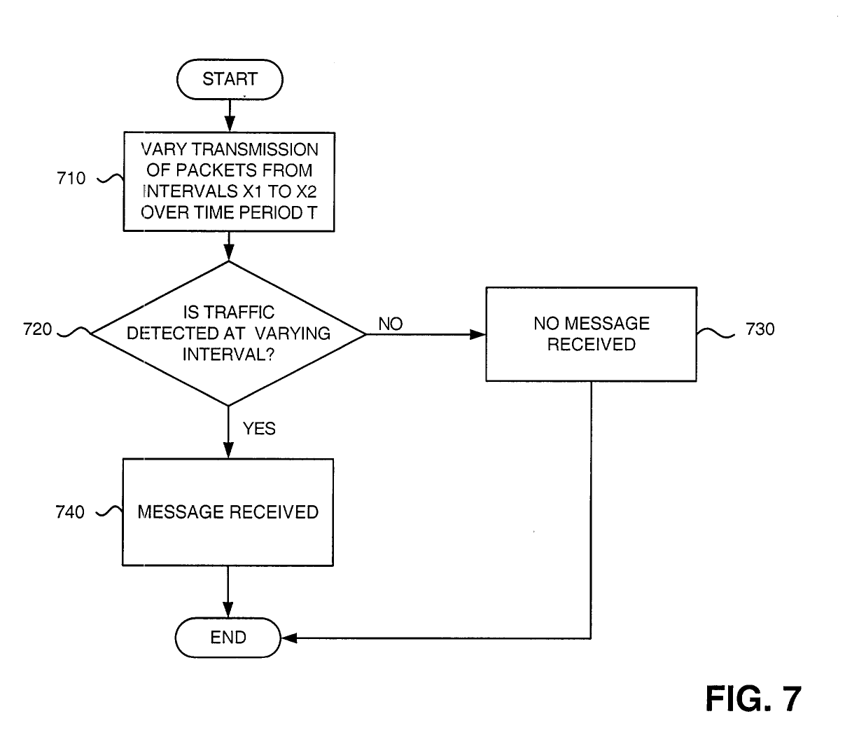

FIG. 7 illustrates a fourth exemplary process for creating a covert channel between a transmit device 110 and an eavesdropping device 130 in an implementation consistent with the present invention. In this implementation, a frequency modulated (FM) sweep is used instead of a fixed pulse. This approach offers the following advantages: (1) the transmission does not dwell for a long time in any one frequency bin, which means that the spectral content of those bins due to the sweep is reduced, and (2) if a replica of the FM sweep is used in a correlation receiver, one gets a drastic increase in signal-to-noise ratio. Furthermore, the matched replica correlator has a decreased sensitivity to other FM pulses of different characteristics.

Processing may begin with transmit device 110 varying the packet transmission interval to receive device 120 from X1 to X2 over a predetermined duration of T seconds (act 710). Transmit device 110 may, for example, sweep through the frequency X1 by sending packets a little faster than frequency X1 and then slowing down the transmission by spacing the packets a littler further apart from each other. After a predetermined period of time T, transmit device 110 may sweep through frequency X2 in a similar manner.

Eavesdropping device 130 may process each T second long interval of traffic looking for a packet periodicity (frequency) that varies in this manner in order to detect whether a message has been sent by transmit device 110 (act 720). Since X1, X2, and T are known by transmit device 110 and eavesdropping device 130 prior to the communication, eavesdropping device 130 may readily detect any message transmitted by transmit device 110.

If the processing of a T second long interval of traffic does not reveal a packet periodicity (frequency) that varies in the manner described above, eavesdropping device 130 determines that no message has been transmitted by transmit device 110 (act 730). If, on the other hand, eavesdropping device 130 detects a packet periodicity (frequency) that varies in the prescribed manner, then eavesdropping device 130 may determine that a message has been transmitted by transmit device 10 (act 740).

Since X1, X2, and T are known only by transmit device 110 and eavesdropping device 130, the likelihood of another party matching and detecting the FM sweep is reduced. Moreover, a simple frequency analysis will fail to show appreciable traffic at any one specific frequency thereby reducing the ability to detect the covert transmission. It will be appreciated that two FM sweeps that cover the same limiting frequencies, but sweep in opposite directions (i.e., low to high, and high to low) may be used simultaneously without interfering with each other.

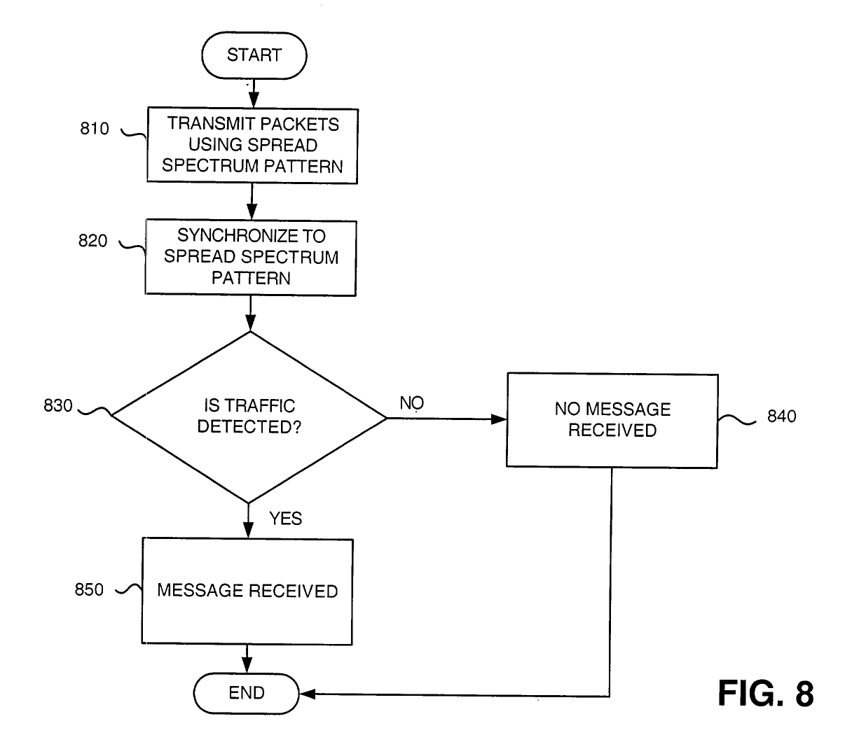

FIG. 8 illustrates a fifth exemplary process for creating a covert channel between a transmit device 110 and an eavesdropping device 130 in an implementation consistent with the present invention. In this implementation, transmit device 110 uses any well-known spread spectrum technique used in radio communications for transmitting a covert message to eavesdropping device 130.

As an example, transmit device 110 may emulate IEEE 802.11 Frequency Hop Spread Spectrum (FHSS), which uses 79 unique frequencies with 66 unique hopping patterns. Each hopping pattern is a pseudo-random pattern known by transmit device 110 and eavesdropping device 130 that indicates the frequencies with which the transmit device 110 will transmit packets and in which order the packet transmission created frequencies will appear. To create the covert channel, transmit device 110 and eavesdropping device 130 synchronize their patterns and hop together. Thus, there is very little signature at any one specific frequency, increasing covertness. The unique hopping patterns are designed such that they do not interfere with one another. Therefore, multiple message “channels” are simultaneously available. Moreover, if specific frequencies are being used, the loss of a single hop will not seriously degrade the detectability of the covert communications (as there are many other frequencies that will not be “used”).

Assume herein that transmit device 110 emulates FHSS techniques by using packet intervals to transmit messages to eavesdropping device 130. It will be appreciated, however, that the process described herein is equally applicable to the use of other techniques for hiding frequency-based transmissions. Processing may begin with transmit device 110 transmitting packets to receive device 120 based on a hopping pattern known only by transmit device 110 and eavesdropping device 130 (act 810). As an example, the hopping pattern may indicate that transmit device 110 is to transmit packets at a first frequency X1 for some time period T, transmit packets at a second frequency X2 for time period T, transmit packets at a third frequency X3 for time period T, and so on. It will be appreciated that frequency X2 may be faster or slower than frequency X1, frequency X3 may be faster or slower than frequency X2, and so on.

Eavesdropping device 130 must synchronize to the hopping pattern in order to receive a covert message (acts 820 and 830). To do so, eavesdropping device 130 monitors packet transmissions from transmit device 110 to receive device 120 at the appropriate time and correct frequency. In the example above, eavesdropping device 130 may look for packets transmitted by transmit device 110 at the first frequency X1 for time period T, at the second frequency, X2 for time period T, at the third frequency X3 for time period T, etc.

If, for example, the monitoring of traffic at the correct hopping pattern does not reveal traffic, eavesdropping device 130 determines that no message has been transmitted by transmit device 110 (act 840). If, on the other hand, eavesdropping device 130 detects traffic that varies in accordance with the hopping pattern, then eavesdropping device 130 may determine that a message has been transmitted by transmit device 110 (act 850). In essence, the above-described processing converts packet streams into a frequency spectrum for transmitting a convert message to a device in a non-secure area.

The covert message sent from transmit device 110 to eavesdropping device 130 at any given time can be a full message, such as “I am here,” or a binary message (e.g., a 1 or a 0). If a binary message is sent, Shannon's Law may be used to further improve the data stream (and reduce the occasional error) using well-known mechanisms for reducing errors in a transmission channel (e.g., forward error correction, parity, etc.).

### Conclusion

Systems and methods, consistent with the present invention, provide a technique for creating covert channels. A transmit device transmits packets to a receive device based on a transmission pattern known only to the transmit device and an eavesdropping device. By knowing this transmission pattern, eavesdropping device can detect messages in the transmission of packets from the transmit device to the receive device that are invisible to the receive device.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while the above implementations focused on the transmission of encrypted data streams, implementations consistent with the present are not so limited. In fact, the present invention is equally applicable to the transmission of unencrypted data streams.

Moreover, the processes described above with respect to FIGS. 4-8 are provided simply by way of example. It will be appreciated that other sophisticated techniques from, for example, digital radar, sonar, and other communication systems can be adapted to packet frequency transmissions.

Series of acts have been described with regard to FIGS. 4-8, the order of the acts may be varied in other implementations consistent with the present invention. Non-dependent acts may be performed in parallel. No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed is:

1. In a network comprising a first device, a second device, and a third device, a method for sending a message between the first device and the third device, comprising:
transmitting packets from the first device to the second device at a fixed interval, the fixed interval being known by the third device;
monitoring, via the third device, the transmitting of packets from the first device to the second device; and
detecting, via the third device, a message from the first device when packets are detected at the fixed interval.

2. The method of claim 1 wherein a value of the fixed interval is communicated to the third device prior to the first device transmitting packets to the second device at the fixed interval.

3. The method of claim 1 further comprising:
performing frequency analysis on the monitored-transmission.

4. The method of claim 3 wherein the detecting includes:
detecting spikes in a frequency graph at the fixed interval.

5. The method of claim 1 wherein the fixed interval includes an uncommon packet transmission interval.

6. The method of claim 1 wherein the message includes a single bit.

7. The method of claim 1 wherein the message includes more than one bit.

8. The method of claim 1 wherein the fixed interval includes a plurality of fixed intervals.

9. The method of claim 8 wherein the transmitting includes:
transmitting packets from the first device to the second device at a first one of the plurality of fixed intervals for a first time period, and
transmitting, after the first time period, packets from the first device to the second device at a second one of the plurality of fixed intervals for a second time period.

10. The method of claim 9 wherein the first time period and the second time period are equal.

11. The method of claim 8 wherein at least one of the plurality of fixed intervals includes an uncommon packet transmission interval.

12. The method of claim 1 wherein the packets transmitted by the first device include encrypted packets.

13. In a network comprising a first device, a second device, and a third device, the third device comprising:
a memory configured to store instructions; and
a processor configured to execute the instructions to:
monitor packets transmitted from the first device to the second device, the packets being transmitted at a fixed interval known by the third device, and
detect a message from the first device when packets are detected at the fixed interval.

14. The third device of claim 13 wherein the processor is further configured to:
perform frequency analysis on the monitored transmission.

15. The third device of claim 14 wherein, when detecting a message, the processor is configured to:
detect spikes in a frequency graph at the fixed interval.

16. The third device of claim 13 wherein the fixed interval includes an interval that is unlikely to occur in normal traffic.

17. The third device of claim 13 wherein the message includes a single bit.

18. The third device of claim 13 wherein the message includes more than one bit.

19. The third device of claim 13 wherein the fixed interval includes a plurality of fixed intervals.

20. The third device of claim 19 wherein, when detecting, the processor is configured to:
detect packets transmitted from the first device to the second device at a first one of the plurality of fixed intervals for a first time period, and
detect, after the first time period, packets from the first device to the second device at a second one of the plurality of fixed intervals for a second time period.

21. The third device of claim 19 wherein at least one of the plurality of fixed intervals includes an interval that is unlikely to occur in normal traffic.

22. A computer-readable medium containing instructions for controlling one or more processors to perform a method for receiving a covert message from a transmit device, the method comprising:
monitoring packets transmitted from the transmit device to a receive device, the packets being transmitted at a fixed interval, and
receiving a message from the transmit device when packets are detected at the fixed interval.

23. The computer-readable medium of claim 22 wherein the fixed interval includes an uncommon transmission interval.

24. A system for transmitting a covert message, comprising:
a memory configured to store a value set to a fixed interval; and
a transmitter configured to:
receive the value, and
transmit two or more packets, each packet transmission being separated in time by the fixed interval, where a different device detects a covert message from the system when the encrypted packets are transmitted at the fixed interval.

25. In a network comprising a first device, a second device, and a third device, a method for sending a message between the first device and the third device, comprising:
transmitting a plurality of packet streams from the first device to the second device at a plurality of corresponding intervals;
monitoring, via the third device, the transmitting of packets from the first device to the second device; and
receiving, via the third device, a message from the first device when packets are detected at the plurality of corresponding intervals during a time period.

26. The method of claim 25 wherein the third device receives a first value representing the number of intervals and second values corresponding to durations of the plurality of intervals prior to the first device transmitting the plurality of packet streams.

27. The method of claim 25 wherein each of the plurality of intervals is different.

28. The method of claim 25 further comprising:
performing frequency analysis on the monitored transmission.

29. A computer-readable medium containing instructions for controlling one or more processors to perform a method for receiving a covert message from a transmit device, the method comprising:
monitoring a transmission of a plurality of packet streams from the transmit device to a receive device, the plurality of packet streams being transmitted at different intervals; and
receiving a message from the first device when packets are detected at the different intervals during a time period.

30. The computer-readable medium of claim 29 wherein the receiving includes:
performing frequency analysis on the monitored transmission.

31. A system for receiving a covert message, comprising:
a memory configured to execute instructions; and
a processor configured to execute the instructions to:
monitor a transmission of a plurality of packet streams from a transmit device to a receive device, each of the plurality of packet streams being transmitted at different intervals; and
receive a covert message from the transmit device when packets are detected at the different intervals during a time period.

32. The system of claim 31 wherein, when receiving the covert message, the processor is configured to:
perform frequency analysis on the monitored transmission.

33. In a network comprising a first device, a second device, and a third device, a method for sending a message between the first device and the third device, comprising:
transmitting packets from the first device to the second device based on a varying transmission pattern, the varying transmission pattern including varying the transmission of packets from a first transmission interval to a second transmission interval over a predetermined time period;
monitoring, via the third device, the transmitting of packets from the first device to the second device; and
receiving, via the third device, a message from the first device when packets are detected at the varying transmission pattern.

34. The method of claim 33 wherein the transmitting includes:
encrypting the packets, and
transmitting the encrypted packets based on the varying transmission pattern.

35. The method of claim 33 wherein the varying transmission pattern includes a frequency modulated sweep.

36. The method of claim 33 wherein the varying transmission pattern includes two frequency modulated sweeps that sweep in opposite directions.

37. A system for receiving a covert message, comprising:
a memory configured to execute instructions; and
a processor configured to execute the instructions to:
monitor a transmission of packets from a first device to a second device, the first device varying the transmission of packets from a first transmission interval to a second transmission interval over a predetermined time period, and
receive a covert message from the first device when packets are detected at an interval that varies from the first transmission interval to the second transmission interval over the predetermined time period.

38. A computer-readable medium containing instructions for controlling one or more processors to perform a method for receiving a covert message from a transmit device, the method comprising:
monitoring a transmission of packets from the transmit device to a receive device, the transmit device varying the transmission of packets from a first transmission interval to a second transmission interval over a predetermined time period, and
receiving a covert message from the transmit device when packets are detected at an interval that varies from the first transmission interval to the second transmission interval over the predetermined time period.

39. In a network comprising a first device, a second device, and a third device, a method for sending a message between the first device and the third device, comprising:
transmitting packets from the first device to the second device using a spread spectrum transmission pattern;
monitoring, via the third device, the transmitting of packets from the first device to the second device; and
receiving, via the third device, a message from the first device when packets are detected at the spread spectrum transmission pattern.

40. The method of claim 39 wherein the spread spectrum transmission pattern includes a frequency hop spread spectrum (FHSS) hopping pattern.

41. The method of claim 40 wherein the FHSS hopping pattern is transmitted to the third device prior to the first device transmitting packets to the second device.

42. The method of claim 41 wherein the FHSS hopping pattern is unknown to the second device.

43. The method of claim 40 further comprising:
synchronizing, via the third device, to the FHSS hopping pattern.

44. A system for receiving a covert message, comprising:
first logic configured to monitor a transmission of packets from a first device to a second device, the first device transmitting the packets so that an interval between packet transmissions creates a set of frequencies, the set of frequencies being managed to achieve a spread spectrum transmission pattern; and
second logic configured to receive a covert message from the monitored transmission using the spread spectrum transmission pattern.

45. The system of claim 44 wherein the spread spectrum transmission pattern includes a frequency hop spread spectrum (FHSS) hopping pattern.

46. The system of claim 45 further comprising:
third logic configured to receive the FHSS hopping pattern prior to the first device transmitting packets to the second device.

47. The system of claim 44 further comprising:
fourth logic configured to synchronize the system to the FHSS hopping pattern.

48. A computer-readable medium containing instructions for controlling one or more processors to perform a method for receiving a covert message from a transmit device, the method comprising:
monitoring a transmission of packets from the transmit device to a receive device, the transmit device transmitting the packets using a spread spectrum transmission pattern that is unknown to the receive device; and
receiving a covert message from the monitored transmission using the spread spectrum transmission pattern.

49. In a network comprising a first device, a second device, and a third device, a method for sending a message between the first device and the third device, comprising:
transmitting packets from the first device to the second device using a transmission pattern that is unknown to the second device;
monitoring, via the third device, the transmitting of packets from the first device to the second device; and
receiving, via the third device, a message from the monitored transmission using the transmission pattern.

50. The method of claim 49 wherein the transmission pattern includes a spread spectrum transmission pattern.

51. The method of claim 49 wherein the transmission pattern includes transmitting packets at one or more fixed intervals.

52. The method of claim 49 wherein the transmission pattern includes transmitting a plurality of packet streams at a plurality of corresponding intervals.

53. The method of claim 49 wherein the transmission pattern includes varying the transmission of packets from a first transmission interval to a second transmission interval over a predetermined time period.

54. A system for receiving a covert message, comprising:
means for monitoring a transmission of packets from a first device to a second device, the transmission of packets being based on a transmission pattern unknown to the second device; and
means for receiving a message from the monitored transmission using the transmission pattern.

55. In a network comprising a first device, a second device, and a third device, a method for sending a covert message between the first device and the third device, comprising:
transmitting packets from the first device to the second device using a transmission pattern that represents, based on a timing of individual packet transmissions, a portion of a frequency spectrum, the first device using a spectrum-based transmission technique to covertly transmit the message to the third device in the transmission of packets to the second device;
monitoring, via the third device, the transmission of packets from the first device to the second device; and
receiving, based on the monitoring, the covert message from the first device when the first device transmits packets using the transmission pattern.

56. The method of claim 55 wherein the spectrum-based transmission technique includes an optical spectrum-based transmission technique.

57. The method of claim 55 wherein the spectrum-based transmission technique includes a radio spectrum-based transmission technique.

58. A system for receiving a covert message, comprising:
a memory configured to store instructions; and
a processor configured to execute the instructions to:
monitor a transmission of packets from a first device to a second device, the first device transmitting the packets using a transmission pattern that represents, based on a timing of individual packet transmissions, a portion of a frequency spectrum, the first device using a spectrum-based transmission technique to covertly transmit a message to the system in the transmission of packets to the second device, and
receive, based on the monitoring, the covert message from the first device when the first device transmits packets using the transmission pattern.

59. The system of claim 58 wherein the spectrum-based transmission technique includes an optical spectrum-based transmission technique.

60. The method of claim 58 wherein the spectrum-based transmission technique includes a radio spectrum-based transmission technique.
